(19) United States
(12) Patent Application Publication
(10) Pub. No.: US 2025/0103873 A1
(43) Pub. Date: Mar. 27, 2025

(54) PHOTONIC NEURAL NETWORK ACCELERATOR

(71) Applicant: NATIONAL UNIVERSITY OF SINGAPORE, Singapore (SG)

(72) Inventors: Zefeng XU, Singapore (SG); Aaron Voon-Yew THEAN, Singapore (SG)

(21) Appl. No.: 18/729,099

(22) PCT Filed: Jan. 12, 2023
(86) PCT No.: PCT/SG2023/050025

§ 371 Date: Jul. 15, 2024

(30) Foreign Application Priority Data
Jan. 18, 2022 (SG) 10202200500V

(51) Int. Cl. G06N 3/067; G06N 3/048

(52) U.S. Cl. CPC G06N 3/0675; G06N 3/048

(57) ABSTRACT

A photonic neural network accelerator, comprising: a Mach Zehnder Interferometer (MZI) comprising phase change material (PCM), the MZI configured to modulate input light passing through a main waveguide; an optical coupler disposed on the main waveguide and configured to split a fraction of the modulated input light into a sub-waveguide from the main waveguide; and an optical resistance switch (ORS) disposed on the sub-waveguide and configured to capture optical information in the sub-waveguide, wherein the optical information comprises optical power and incident wavelength.

### FIELD OF INVENTION

The present invention relates broadly, but not exclusively, to a photonic neural network accelerator.

### BACKGROUND

Artificial Neural Network (ANN) is a computational model for the mimic of human brain in information processing. It comprises nodes, namely “neurons”, which are connected to each other through “synapses”. The computational complexity of ANN in model iterations requires large computational ability for multiply-and-accumulate (MAC) operations. With the continuous advancement of ANN, the past decade has witnessed an exponential rise in demand for high computing speed and low energy consumption. As this demand continues, graphics processing unit (GPU) and even central processing unit (CPU)/GPU heterogenous architectures become attractive options for ANN acceleration, since they offer more computational parallelism than CPU. Besides, more electronics architectures have been also developed, such as Application-Specific Integrated Circuit (ASIC) and Field-Programmable Gate Array (FPGA) chips to increase ANN computing speed and efficiency. However, these architectures are still limited by electrical interconnects with resistance and capacitance (RC) parasitic effects and the twilight of Moore's law for CMOS technology.

To address the above issues, with ultra-low computation loss, sub-nanosecond latencies and abundant computing parallelism, photonics has been considered as a promising solution. Meanwhile, photonics can deliver higher bandwidth, better energy-efficiency, and more complex functionality.

Recent works have demonstrated the potential of photonic neural network in the acceleration of ANN. First photonic ANNs were implemented in free-space light platform using optical lens, with a disadvantage of low integration. Along with the rapid development of integrated photonics, the combination of Micro-Ring-Resonator (MRR)-based weighting bank and array of photodetectors processes successfully small-scale matrix multiplication with assistance of Wavelength Division Multiplexing (MWM) technology, but it is not an efficient method due to the footprint of MRRs. To enlarge the matrix computation scale, Mach-Zehnder Interferometer (MZI) mesh on an integrated photonics chip has been proposed for MAC operations, which corresponds to one of the basic functions of ANN, weighting layer, to interpret incoming signals, with superior propagation speed and power efficiency. However, another necessary basic function, applying in-situ nonlinear activation function to the sum of weighted inputs after MAC functions, remains an open challenge in photonic neural networks. Without nonlinear activation function, photonic ANN has worse performance: lower recognition accuracy and slower convergence rate. This is because the network complexity is low and unchanged while increasing the number of linear layers and linear photonic ANN model is difficult to fit real physical world problems, which hardly follow straightforward linearity.

To address this challenge, several approaches for in-situ nonlinear activation accelerator in photonics have been proposed, providing suitable paths to achieve a complete suite of ANN in photonics. For example, two-section distributed-feedback (DFB) lasers, vertical-cavity surface-emitting laser (VCSEL) and disk lasers have shown promising results, but they are bottlenecked by network scale, frequency of access and power consumption. Moreover, their nonlinear activation responses tend to be fixed during accelerator fabrication, but the nonlinear activation forms should be reprogrammed according to different ANN models and data sets. Thus, as a complementary approach, a more straightforward and flexible implementation is attained by calculating the nonlinear functions in CPU, which connects physical photonic neural networks through electrical-to-optical (E/O) and optical-to-electrical (O/E) converters. Unfortunately, it still suffers from the limitations of low efficiency and high latency with frequent access, due to poor performance of parallel computation. Another challenge associated with this approach is the adoption of highly efficient E/O and O/E converter devices, which greatly influence the power consumption of the whole system.

### SUMMARY

According to one embodiment, there is provided a photonic neural network accelerator. The photonic neural network accelerator comprises a Mach Zehnder Interferometer (MZI). The MZI comprises phase change material (PCM) and the MZI is configured to (i.e. capable of) modulate (modulating) input light passing through a main waveguide. The MZI is disposed on the main waveguide. The photonic neural network accelerator further comprises an optical coupler disposed on the main waveguide and is configured to split a fraction of the modulated input light into a sub-waveguide from the main waveguide. The sub-waveguide is in optical communication with the main waveguide via the coupler. The photonic neural network accelerator further comprises an optical resistance switch (ORS) disposed on the sub-waveguide and is configured to capture optical information in the sub-waveguide. The optical information comprises optical power and incident wavelength. The photonic neural network accelerator further comprises an electrical control unit (ECU) to simultaneously drive the ORS and MZI.

The ORS comprises an active material configured to absorb the fraction of the modulated input light to drive a photo-response resistance switching process of the ORS, wherein the photo-response resistance switching process of the ORS converts the fraction of the modulated input light into an electrical signal. The active material exhibits linear resistance switching with respect to the optical power.

The ORS further comprises an electrode configured to send the above-mentioned electrical signal to the ECU. The electrode may be a gold electrode (as will be described in more detail below with reference to FIG. 8). The ECU is configured to detect the above-mentioned electrical signal, and send a corresponding feedback control signal to the MZI for re-modulation of input light passing through the main waveguide.

The ECU may be configured to send the corresponding feedback control signal to the MZI for re-modulation of the input light until the photo-response resistance switching process of the ORS is reset.

The ORS further comprises a micro-mirror to redirect the fraction of the modulated input light to the switching material (and consequently, to a top of the sub-waveguide).

The active material comprises a Molybdenum disulfide (MoS₂) switching material configured to capture the optical information. The MoS₂ switching material comprises a film spin-coated on another electrode (i.e. different from the above-mentioned gold electrode) from a MoS₂ ink. The another electrode may be an ITO electrode (as will be described in more detail below with reference to FIG. 8).

The MoS₂ ink may be obtained through an electrochemical intercalation assisted exfoliation of a MoS₂ bulk.

The photonic neural network accelerator is capable of executing a nonlinear activation function.

According to another embodiment, there is provided a photonic neural network comprising a photonics neural network accelerator as described above.

According to another embodiment, there is provided a method of fabricating a photonic neural network accelerator. The method comprises the steps of: providing a Mach Zehnder Interferometer (MZI) comprising phase change material (PCM), the MZI configured to modulate input light passing through a main waveguide; providing an optical coupler disposed on the main waveguide, wherein the optical coupler is configured to split a fraction of the modulated input light into a sub-waveguide from the main waveguide; and providing an optical resistance switch (ORS) disposed on the sub-waveguide, wherein the ORS is configured to capture optical information in the sub-waveguide, and wherein the optical information comprises optical power and incident wavelength.

The method further comprises providing the ORS with an active material that is configured to absorb the fraction of the modulated input light to drive a photo-response resistance switching process of the ORS, wherein the photo-response resistance switching process of the ORS converts the fraction of the modulated input light into an electrical signal.

The method further comprises providing an electrical control unit (ECU) to simultaneously drive the ORS and MZI.

The method further comprises providing the ORS with an electrode that is configured to send the electrical signal to the ECU.

The active material comprises a Molybdenum disulfide (MoS₂) switching material configured to capture the optical information.

The method further comprises providing the ORS with a micro-mirror to redirect the fraction of the modulated input light into the MoS₂ switching material.

The MoS₂ switching material comprises a film spin-coated on another electrode from a MoS₂ ink, and the MoS₂ ink is obtained through an electrochemical intercalation assisted exfoliation of a MoS₂ bulk.

### BRIEF DESCRIPTION OF THE DRAWINGS

Embodiments are provided by way of example only, and will be better understood and readily apparent to one of ordinary skill in the art from the following written description, read in conjunction with the drawings, in which:

FIG. 1 is a schematic of a programmable nonlinear photonic neural network accelerator, according to an embodiment.

FIG. 2 is a schematic of an optical resistance switch (ORS), according to an embodiment.

FIG. 3 is a circuit diagram of an electrical control unit (ECU), according to an embodiment.

FIG. 4 is a flow chart illustrating a work process of an accelerator, according to an embodiment.

FIGS. 5(a) to (c) show with different initial parameters setting, an accelerator according to embodiments of the invention can perform different types of nonlinear activation functions, like sigmoid (N1), softplus (N2) and clamped ReLU (N3), respectively. FIGS. 5(a) to (c) shows nonlinear activation functions output transmission power as a function of normalized input signal power.

FIG. 6 is a result matrix of a MNIST classification task using embodiments of the invention.

FIG. 7 is a schematic of a photonic neural network integrated with a nonlinear accelerator, according to an embodiment of the invention.

FIG. 8(a) is a schematic of a 2×2 MZI comprising couplers and phase-shifters (θ and φ), according to an embodiment of the invention.

FIG. 8(b) is a schematic of a nonlinear accelerator, according to an embodiment of the invention.

FIG. 8(c) is a surface scanning image of a patterned MoS₂ material obtained from an Atomic Force Microscope (AFM) showing the morphology of a stack of 2D MoS₂ sheets according to an embodiment of the invention.

FIG. 8(d) is a surface scanning image of a surface of a MoS₂ film according to an embodiment of the invention.

FIG. 8(e) shows the Raman spectra of spin-coated solution-processed MoS₂ material according to an embodiment of the invention.

FIGS. 9(a) and (b) show the bipolar resistance switching characteristics of an ORS according to an embodiment of the invention that is activated by different light power of 520 nm and 405 nm guided light, respectively.

FIGS. 9(c) and (d) show mean V_{SET} variation with applied optical power at 520 nm and 405 nm, respectively.

FIGS. 9(e) to (h) show the endurance characteristic of an ORS according to an embodiment of the invention.

FIG. 9(i) shows a comparison of switching characteristic for different input wavelength but with the same optical power.

FIGS. 10(a) to (c) show conducing states in the ORS according to an embodiment of the invention at (a) initial state, (b) SET process without optical input, and (c) SET process with optical input.

FIGS. 10(d) to (f) show corresponding energy band diagrams of the ORS according to an embodiment of the invention at (d) initial state, (e) SET process without optical input, and (f) SET process with optical input.

FIG. 11(a) is a simplified schematic of a nonlinear accelerator, according to an embodiment of the invention.

FIG. 11(b) is a circuit diagram of an electrical control unit (ECU), according to an embodiment, and is similar to the circuit diagram shown in FIG. 3.

FIGS. 11(c) to (f) illustrate the runtime process of an accelerator according to an embodiment of the invention. FIG. 11(c) is a time-series diagram of data obtained in marked nodes over 4 cycles. FIGS. 11(d) to (f) show working states in the nonlinear accelerator at (d) rising state, (e) dropping state and (f) RESET state, respectively.

FIG. 12(a) is a schematic a photonic neural network comprising an ORS-based nonlinear accelerator (ORS-PNN), according to an embodiment of the invention.

FIG. 12(b) shows the testing accuracy of the ORS-PNN on a MINST dataset, as a function of layer number.

FIG. 12(c) shows the calculated loss at each epoch during the learning procedure with 5 layers.

### DETAILED DESCRIPTION

Embodiments will be described, by way of example only, with reference to the drawings. Like reference numerals and characters in the drawings refer to like elements or equivalents.

A photonic neural network has been sought as an alternative solution to surpass the efficiency and speed bottlenecks of electronic neural networks. Although an integrated Mach-Zehnder Interferometer mesh can perform vector-matrix multiplication, the lack of in-situ nonlinear activation function suppresses further advancement in photonic neural networks. The present disclosure relates to an efficient nonlinear accelerator comprising a solution-processed two-dimensional MoS₂ optical switch, which exhibits linear resistance switching with respect to optical power. Embodiments enable reconfiguration of a wide variety of nonlinear responses. Embodiments enable the integration of photonic integrated circuits (PIC), which extend the frontiers in machine learning and information processing.

The present disclosure relates to an optical-switch-based nonlinear photonics neural network accelerator capable of performing different types of nonlinear activation functions via initial conditions control.

The present disclosure relates to an optical-to-optical nonlinear activation accelerator in an optical-electrical hybrid architecture which can alleviate the aforementioned challenges on both device and accelerator architecture sides. In an implementation, there is provided an optical resistance switch (ORS) based on solution-processed two-dimensional (2D) MoS₂, whose memristive behavior is sensitive to incident light. Embodiments have an advantage of the ease of large-scale integration with a low thermal budget, which is critical in processing with highly sensitive optical components on a chip. Furthermore, the ORS switching voltage from high resistance state (HRS) to low resistance state (LRS) shows a linear dependence to the power of incident light, bridging the ORS to the photonic ANN for nonlinear activation accelerator. Based on this unique photosensitive device, the accelerator features a variety of nonlinear activation response. The nonlinear accelerator includes the ORS, low-power control unit and MZI with tunable phase change material (PCM). Additionally, embodiments allow for the possibility of active tunability of nonlinear response under different initial conditions.

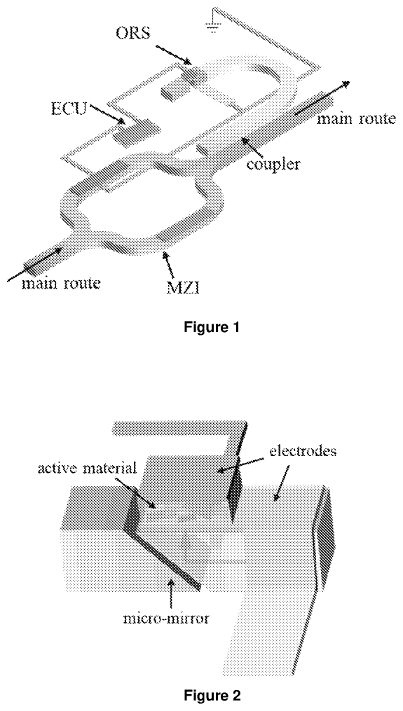

According to one implementation, there is provided a programmable nonlinear photonics neural network accelerator as shown in FIG. 1. The accelerator comprises an optical coupler which is configured to split a fraction of light into a bent sub-waveguide from a main waveguide route. The accelerator further comprises an optical resistance switch (ORS) to capture optical information in the sub-waveguide in terms of optical power and incident wavelength, an electrical control unit (ECU) to drive the ORS and Mach Zehnder Interferometer (MZI) simultaneously, and a MZI with phase change material (PCM) to achieve a feedback loop modulating the light passing through the main waveguide route.

According to one implementation, the ORS comprises a micro-mirror to redirect the split light into a top of waveguide, followed by an active material to absorb the light to drive the switching process of the ORS, as shown in FIG. 2. A top electrode sends the feedback signal to the MZI in the main route.

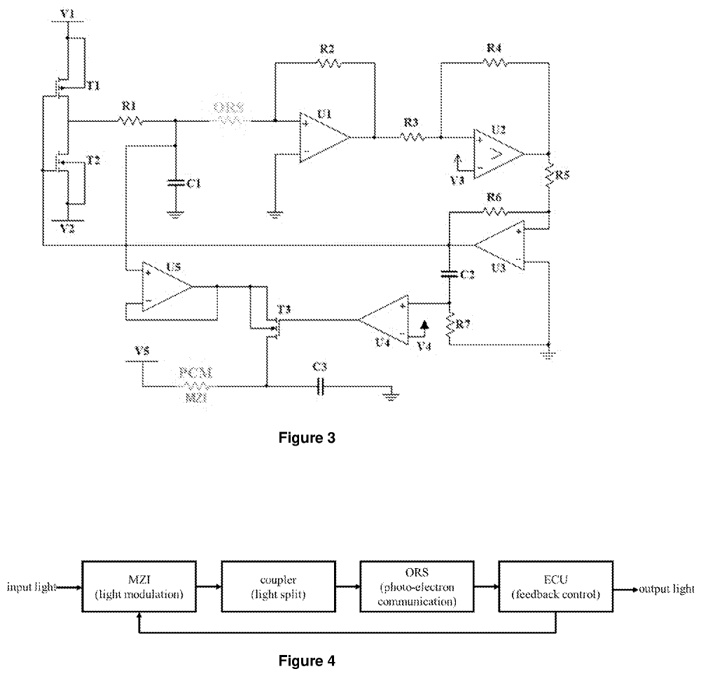

The circuit diagram of an ECU according to one implementation is shown in FIG. 3. Positive (V1) and negative (V2) power supplies power the ORS through a reversed switch-pair, constituted by a PMOS transistor (T1) and a NMOS transistor (T2), after a specified RC delay (τ=R1C1, where τ is RC time constant). Next, it is followed by a trans-impedance amplifier (U1) to convert current into voltage, a hysteresis comparator (U2) to judge the resistance state of the ORS (LRS or HRS), and a voltage reverser (U3). Initially increasing voltage VC1 is applied to ORS with T1 on and T2 off, and while the current IORS suddenly increased due to the ORS switching under illumination, output voltage of U3 reverses and induces T1 off and T2 on. In this case, VC2 starts to be pulled down by V2. Simultaneously, another route generates a pulse activated by reversed output of U3 through a specified RC delay (τ=R7C2) and a comparator (U4). This pulse opens one transistor switch (T3) within the pulse time to “read” the maximum voltage of VC1 (VSET) using a voltage follower (U5) and this VSET is applied back to PCM on one arm of MZI to modulate the light go through the main route.

FIG. 4 is a flowchart showing the work process of the accelerator. At step 402, input light goes through the MZI for light amplitude modulation, which can be calculated as

$${\vec{E}}_{o} = \frac{{\vec{E}}_{I}}{2} ( {e}^{- j ( \frac{π V}{{V}_{π}} )} + {e}^{- j δ} ) \qquad ( 1 )$$

$${V}_{π} = \frac{λ}{{n}^{3}} \frac{1}{r} \frac{d}{L} \qquad ( 2 )$$

where \vec{E}ₗ and \vec{E}ₒ are the input and output electrical fields of MZI respectively and V_{π} is the half-wave voltage, which causes phase change π of phase shifter. And λ is the input wavelength, n is the corresponding refractive index, r is electro optic coefficient, L is the length of interferometric arms and d is the thickness of PCM.

At step 404, the coupler splits the modulated light into one main route and one sub-route with a portion (β).

At step 406, the ORS converts the split light signal into the electrical signal via the photo-response resistance switching process. The relationship between light and electrical signals can be described as

$$V = {kP}_{abs} + b \qquad ( 3 )$$

where k is the slope, P_{abs} is the absorbed optical power of ORS, and b is the intercept. The absorption coefficient is α.

At step 408, the ECU detects the electrical signal sent by the ORS and sends the feedback control signal to the MZI for re-modulation of input light, until the ORS switching process is reset. Combining the expressions above, the mathematical form of nonlinear activation function achieved by nonlinear accelerator can be written as

$${P}_{O} = \frac{{P}_{I}}{2} {cos}^{2} ( \frac{\frac{π ( k α β {P}_{O} + b )}{{V}_{π}} + δ}{2} ) \qquad ( 4 )$$

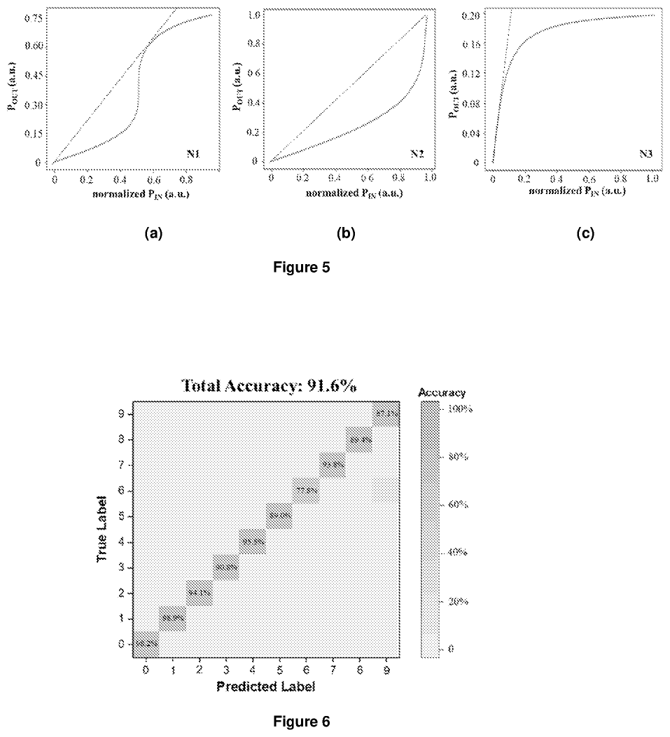

As shown in FIG. 5, with different initial parameters setting, the accelerator according to embodiments of the invention can perform different types of nonlinear activation functions, like sigmoid (N1), softplus (N2) and clamped ReLU (N3).

### Accelerator Performance

The Modified National Institute of Standards and Technology (MNIST) handwritten digits classification task is used for validating embodiments of the invention. As shown in FIG. 6, the total accuracy of classification reaches 91.6%, which is high enough for commercial applications.

Embodiments of the invention may overcome limitations faced by commercially available approaches. In particular, embodiments of the invention can be embedded into the photonics neural network circuit without complex and long-distance interconnection and external controls. Embodiments of the invention can also be embedded into the gap of the photonics circuit without the need for extra chip area. Further, embodiments of the invention support on-chip learning since it enables frequent access and refreshing, and it is with stable functionality. Moreover, embodiments of the invention do not require any E/O or O/E conversion by using an optical resistance switch (ORS). A photonics circuit integrated with embodiments of the invention can be used for many applications without the limit of mobility, flexibility, and volume. Embodiments of the invention are programmable to achieve different types of nonlinear activation functions for different neural network tasks.

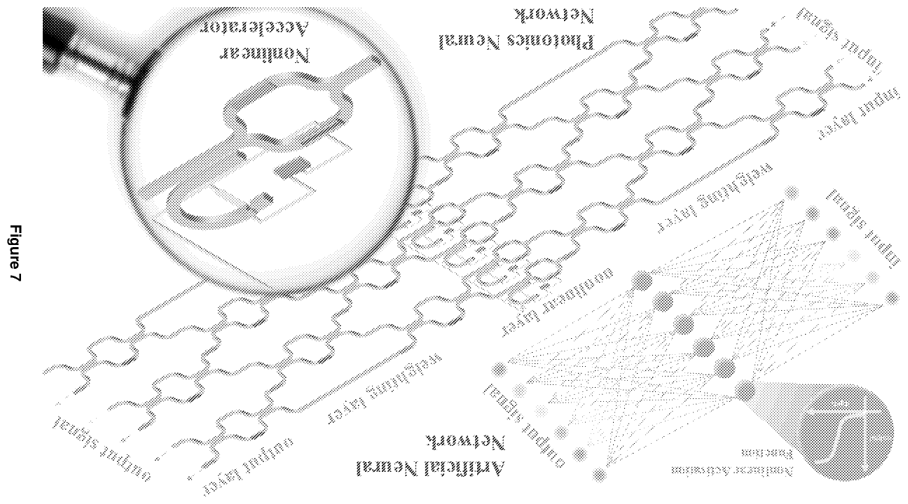

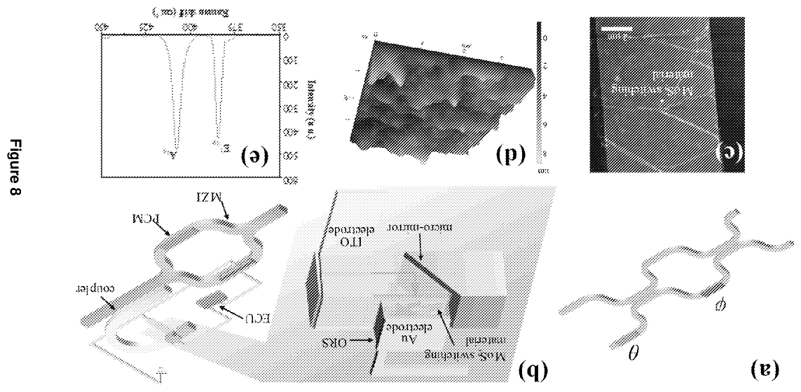

FIG. 7 is a schematic of a photonic neural network integrated with a nonlinear accelerator, according to an embodiment of the invention. An Artificial Neural Network (ANN) comprises multiple hidden layers, each with a weighting layer to compute weighting matrix and summation, and a nonlinear layer to execute nonlinear activation function(s). In a photonic neural network, a programmable MZI mesh contains inner phase-shifters (e.g. marked in FIG. 8(a) as φ) and outer phase-shifters (marked in FIG. 8(a) as θ) to multiply optical signal(s) from the input layer by an assigned weight value and sum over it. Following the MZI mesh, nonlinear accelerators apply nonlinear activation functions to the output of the MZI mesh. By repeating a combination of MZI mesh and nonlinear accelerators, photonic neural network achieves in-situ ANN computation with a large number of nodes and connections.

### Optical Resistance Switch Characteristic

According to an implementation, the MZI-mesh based weighting layer is configured with some 2×2 MZIs as shown in FIG. 8(a). The 2×2 MZI comprises two couplers and two phase-shifters (θ and φ). The MZI unit can perform all rotations in unitary group of degree two, U(2), by adjusting PCMs θ and φ. In this regard, any weighting matrix can be decomposed into the product of several U(2). Thus, the MZI mesh is capable of adding any weighting matrix into optical input. The unitary transformation U(2) of MZI can be given by

$${U}_{MZI} = \frac{1}{2} [ \begin{matrix}{e}^{i θ} ( {e}^{i φ} - 1 ) & {e}^{i θ} ( {e}^{i φ} + 1 ) \\ i ( {e}^{i φ} + 1 ) & 1 - {e}^{i φ}\end{matrix} ] = [ \begin{matrix}{u}_{11} & {u}_{12} \\ {u}_{21} & {u}_{22}\end{matrix} ] \qquad ( 5 )$$

FIG. 8(b) is a schematic of a nonlinear accelerator, according to an embodiment of the invention. The nonlinear accelerator comprises an optical coupler to split a fraction of light into a bent sub-waveguide from a main waveguide route, a micro-mirror to divert light into a top of the sub-waveguide, a ORS with MoS₂ switching material to capture the optical information in terms of optical power and incident wavelength, an electrical control unit (ECU) to drive the ORS and MZI simultaneously, and a MZI with PCM to achieve a feedback loop modulating the light passing through the main route. Advantageously, there is no need for extra footprint space for the control unit compared with prior art solutions, since the control unit is small enough to occupy gaps within the photonics network. The ORS is integrated with a micro-mirror and plays a key role in the accelerator function.

According to an implementation, the ORS employs solution-processed MoS₂ switching material, which is a film spin-coated on the bottom electrode from a MoS₂ high-concentrated ink. The ink is prepared through ion-intercalation-driven exfoliation of a MoS₂ bulk. Surface scanning image of patterned MoS₂ material obtained from Atomic Force Microscope (AFM) (see FIG. 8(c)) shows the morphology of a stack of 2D MoS₂ sheets, which is important for switching characteristic of ORS. The optical properties of this spin-coated film are strongly correlated to its surface roughness, which requires precise control during fabrication. As shown in FIG. 8(d), surface scanning image demonstrates an excellent surface condition on MoS₂ film with the roughness of 1.2 nm, and this condition meets the requirement of constructing ORS needed for nonlinear accelerators. This material enables ORS to be well fabricated on the top of sub-waveguide and compounded of an ITO-MoS₂-Au sandwich-like structure (see FIG. 8(b)). The middle layer is stacked by several 2D MoS₂ sheets during spin-coating process. To verify the layer number of each sheet, Raman Spectra were collected from MoS₂ film on SiO₂/Si substrate. The Raman signal of the E¹_{2g} and A_{1g} shows strong peaks at 383.5 cm⁻¹ and 408.2 cm⁻¹ (see FIG. 8(e)). The analyses above show that integrating the ORS with a photonics circuit is possible.

### Solution-Processed MoS₂ Preparation

High-quality semiconducting MoS₂ nanosheets may be fabricated with an electrochemical intercalation assisted exfoliation method. Subsequently, the exfoliated MoS₂ nanosheets may be dispersed in isopropanol to obtain the final MoS₂ ink, which is used for device fabrication.

### ORS Fabrication and Characterization

Solution-processed MoS₂ is spin-coated on p-Si with 90 nm SiO₂ layer, followed by electron beam lithography and rapid thermal annealing. Referring back to FIG. 8(b), the ITO (40 nm) may be deposited by sputter followed by lithography patterning and ICP-RIE etching to form electrodes. Another electrode using Au (40 nm) may be constructed by lift-off after electron beam photolithography and deposition using electron beam evaporator.

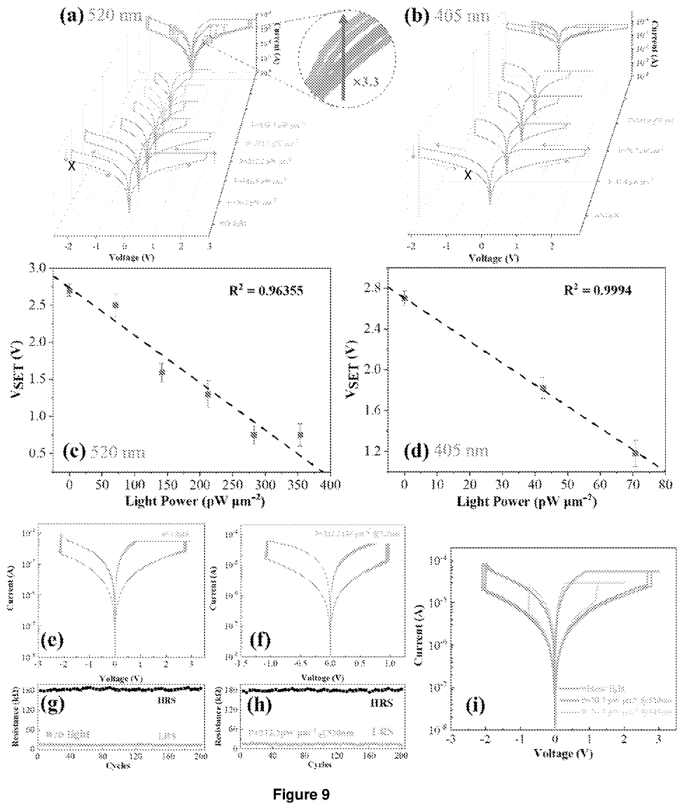

FIGS. 9(a-b) show the bipolar resistance switching characteristics of the ORS activated by different light power of 520 nm and 405 nm guided light, respectively. For a typical current-voltage (I-V) measurement without light input (see foremost lines in FIG. 9(a-b) marked “X”), a DC voltage is applied to the Au top electrode and the ITO bottom electrode is grounded. During the voltage sweep from 0 to 3V, an obvious abrupt increase of current can be observed while applied voltage reaches 2.7 V, which is defined as V_{SET}, and the ORS is switched from HRS to LRS. By controlling the compliance current limit, irreversible device breakdown due to too large current can be avoided. In the reversed sweep, negative voltage (>−2.2V) makes the ORS completely return to HRS, termed as RESET process. The V_{SET} signifies that, at this voltage, the electrical resistance state of the ORS, with capacity of non-volatile memory, can be changed. This switching characteristic is conducted under different light power with a fixed wavelength irradiance as shown in other lines behind line “X” (i.e. towards the background) in FIGS. 9(a-b). The light is absorbed in the MoS₂ material after transmission through bottom ITO electrode, as the photon energy of 2.38 eV and 3.06 eV are larger than the bandgap of MoS₂ material at room temperature (2.25 eV). Because of more photon-generated carriers in MoS₂ material, the current of ORS in the HRS increases with fixed wavelength (inset in FIG. 9(a)). During the SET process, V_{SET} steadily decreases from 2.7 to 0.6 V with the increased optical power from 70.7 to 282.9 pW μm⁻² for 520 nm wavelength, followed by a saturation of V_{SET}. The similar phenomenon can be observed for 405 nm wavelength illumination as shown in FIG. 9(b): V_{SET} declines from 2.7 to 1.2 V with increased optical power from 0 to 70.7 pW μm⁻² before a saturation of V_{SET}. This effect related to input optical power is summarized in FIG. 9(c-d) for 520 nm and 405 nm, respectively, and it can be fitted perfectly in straight line (the black dash lines) with high coefficient of determination (R²), 0.9635 and 0.9994 for 520 nm and 405 nm respectively.

This linear relationship can be expressed as

$$V = {kP}_{a b s} + b \qquad ( 6 )$$

where k is the slope, P_{abs} is absorbed optical power of ORS, and b is the intercept.

The feature of linearity represents the ability to perceive the optical power and convert it into electrical parameter (V_{SET}) linearly for the nonlinear accelerator. As for the working function in the process of the accelerator, the response of the ORS is nonlinear since briefly it is a sudden change of output in terms of current, which is a necessary signal driving the accelerator. Thus, the ORS's optical characteristic is unique and different from normal photodetectors, which detect optical power and directly convert it into current linearly. This characteristic of the ORS is critical to realizing the nonlinear activation accelerator.

Frequent access to the nonlinear activation accelerator requires that the ORS can maintain its switching characteristic in many cycles. Furthermore, the resolution (R) of ORS is immediately relevant with the variation of its characteristic at each optical power input, which is defined as bellow

$$R = {arg max}_{n} \vert \{ {V}_{1} , {V}_{2} , {V}_{3} , {V}_{4} , … {V}_{n} ∈ {V}_{r} \} \vert , {V}_{i} ⋂ {V}_{j} = ∅ , i \neq j \leq n \qquad ( 7 )$$

where |x| represents the number of elements in a set x, Vᵢ means the V_{SET} variation of the ith input power state, and Vᵣ corresponds to the range of possible V_{SET}. To maximize the power perception resolution, the variation of V_{SET} at each optical power input should be as small as possible. The endurance characteristic of ORS at room temperature is shown in FIGS. 9(e-h). The ORS according to embodiments of the invention showcases an excellent low cycle-to-cycle variation in resistance states with minor fluctuations without (FIG. 9(g) and with light input (FIG. 9(h)) over 200 continuous resistive-switching cycles. Moreover, the variation of V_{SET} ranges from 0.03 to 0.08 V for different optical input power, which means the ORS can differentiate up to 39 optical power independent states. To further evaluate the performance of the ORS according to embodiments of the invention, the comparison of switching characteristic for different input wavelength but with the same optical power at 70.7 pW μm⁻² is shown in FIG. 9(i). It can be seen clearly that larger input photon energy induces lower V_{SET} and smaller switching window.

### Optical Resistance Switch Operation Mechanism

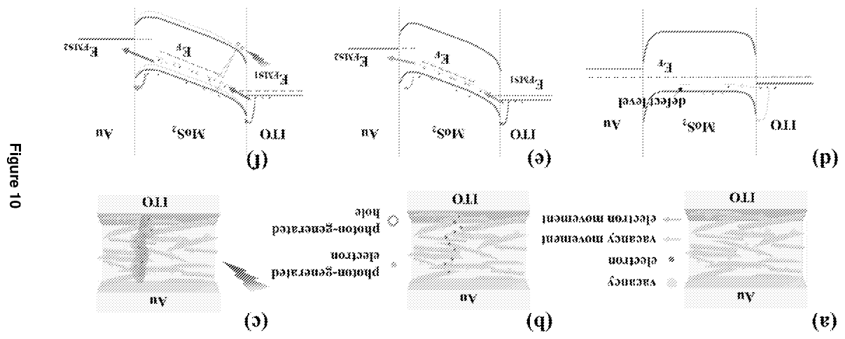

The resistance switching characteristic and optical response are associated with vacancy transition and photon-induced heat generation. The resistance switching processes are explained in FIGS. 10 (a-c) and corresponding energy band diagrams at different states are shown in FIGS. 10 (d-f). The conducing states in the ORS shown at (FIG. 10a) initial state, (FIG. 10b) SET process without optical input, and (FIG. 10c) SET process with optical input. Corresponding energy band diagram of ORS at (FIG. 10d) initial state, (FIG. 10e) SET process without optical input, and (FIG. 10f) SET process with optical input.

For the MoS₂ solution-processed material, sulphur vacancies (V_{S}) are created at the edge of each 2D sheets during solution-exfoliation process. Lower electron affinities of MoS₂ (around 3.0 eV) than work functions of Au and ITO (5.1 eV and 4.7 eV respectively) indicates two Schottky barrier contacts are formed on both interfaces of MoS₂. In this case, few electrons are able to pass over or tunnel the barrier and no vacancy filament is constructed. In the SET process, the external bias reduces the width and height of Schottky barrier and therefore increases the electron thermal emission and tunnelling rate. These result in the increased current, which reinforces the vacancy migration along the edge of MoS₂ sheets to one naturally occurred conducting pathway in the whole MoS₂ layer via joule heating, until the vacancy “bridge” is constructed. Then the ORS achieves resistance switching from HRS to LRS due to much increased tunnelling electrons with higher vacancy defect concentration (quasi-continuous defect level) in the pathway. For photon-response behavior of ORS, by absorbing photons in the interfaces, photoelectric effect creates electron-hole pairs, and the generated electrons are excited into V_{S} defect level and conductance band in the room temperature. Besides, photogating effect that originates from trapped photogenerated electrons can further lower the Schottky barriers. Thus, under illumination, the current increases with increasing carrier concentration (3.3 times as shown in the inset of FIG. 9(a)) and it produces more heat from joule heating. Current-induced Joule heating and optical power dissipation accelerate the V_{S} movement to form the quasi-continuous defect level. It reduces the dependency on external bias and thus V_{SET} decreases under illumination.

### Accelerator Architecture Based on Optical Resistance Switch

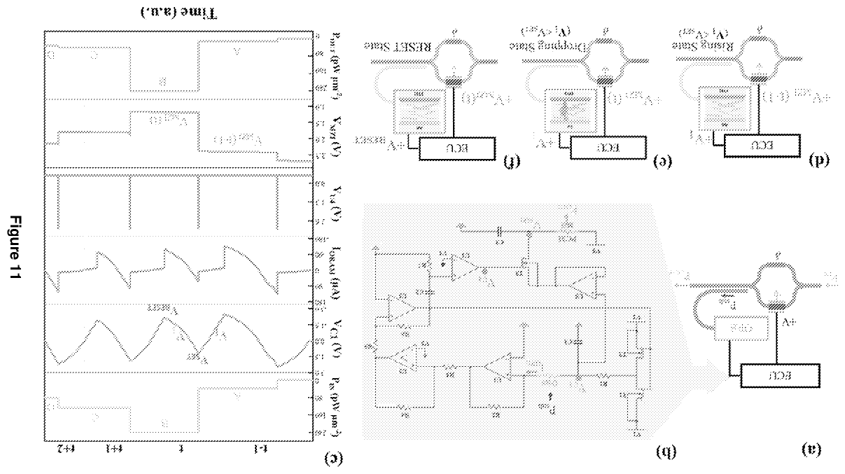

For the convenience of illustration, the accelerator architecture as shown in FIG. 8(b) is simplified in FIG. 11(a), where the grey lines and black lines represent optical waveguides and electrical pathways, respectively. At the beginning, optical signal out of MZI (P_{sub}) enters a directional coupler which splits a portion (β) of light into the ORS through a bent sub-waveguide. The ORS absorbs the light with absorption coefficient (α) and promotes the ORS to switch the resistance at V_{SET}, which is an indicator of the P_{abs} with linear relationship. Here, it is assumed the input light signal is with electric field intensity (E) and the corresponding optical power is given by

$$P = \frac{a b}{4} {E}^{2} \frac{1}{{Z}_{T E}} \qquad ( 8 )$$

$${Z}_{T E} = \frac{η}{1 - {( λ / {λ}_{C} )}^{2}} \qquad ( 9 )$$

$$η = \sqrt{μ / ε} \qquad ( 10 )$$

$${λ}_{C} = 2 a \qquad ( 11 )$$

where a and b are width and depth of the rectangular waveguide respectively, ε is dielectric constant, μ is magnetic permeability.

The circuit diagram of an ECU according to one implementation as shown in FIG. 11(b) is similar to the circuit diagram shown in FIG. 3.

FIGS. 11(c) to (f) illustrate the runtime process of an accelerator according to an embodiment of the invention.

FIG. 11(c) is a time-series diagram. While V_{C1} increases before reaching at V_{SET} (t) (see FIG. 11(d)), V_{MZI} (t−1) is applied constantly to PCM. Until V_{SET} changes the state of ORS, V_{MZI} (t−1) suddenly turns into V_{MZI} (t) controlled by one pulse of V_{U4}. Subsequently, it is followed by a decreasing V_{C1} (see FIG. 11(e)) to VRESET, at which ORS switches back from LRS to HRS but V_{MZI} (t) is still held until next cycle of resistance switching in ORS (see FIG. 11(f)).

As shown in FIG. 11(c), a perfect response of input optical signal in several loops can be viewed, and an accelerator according to an embodiment of the invention easily satisfies one important requirement for a photonic neural network: response frequency (voltage sweeping frequency) must be higher than optical signal changing frequency, since the voltage sweeping frequency depends on controllable R1C1 delay. The formula for sweeping voltage is given by

$${V}_{C 1} = \{ \begin{matrix}( {V}_{1} - {V}_{2} ) ( 1 - {e}^{\frac{- t}{{R}_{1} {C}_{1}}} ) + {V}_{2} , & {V}_{RESET} < {V}_{C 1 ↑} < {V}_{SET} \\ ( {V}_{2} - {V}_{1} ) ( 1 - {e}^{\frac{- t}{{R}_{1} {C}_{1}}} ) + {V}_{1} , & {V}_{RESET} < {V}_{C 1 ↓} < {V}_{SET}\end{matrix} \qquad ( 12 )$$

Moreover, a benefit of having an adjustable PCM (δ) in another arm of MZI as shown in FIG. 11(a) is that, in principle, an accelerator according to an embodiment of the invention can be programmed to synthesize different activation functions, e.g. as previously shown in FIG. 5. In particular, FIGS. 5(a) to (c) show various nonlinear activation functions, sigmoid, softplus and clamped rectified linear unit (ReLU), respectively, at different initial δ values. Notably, every loop in FIG. 11(c) corresponds to different states of nonlinear function in FIG. 5(a). This reconfigurability allows the possibility of selecting suitable nonlinear functions for different specific tasks and distinguishes embodiments of the invention from previous nonlinear function approaches.

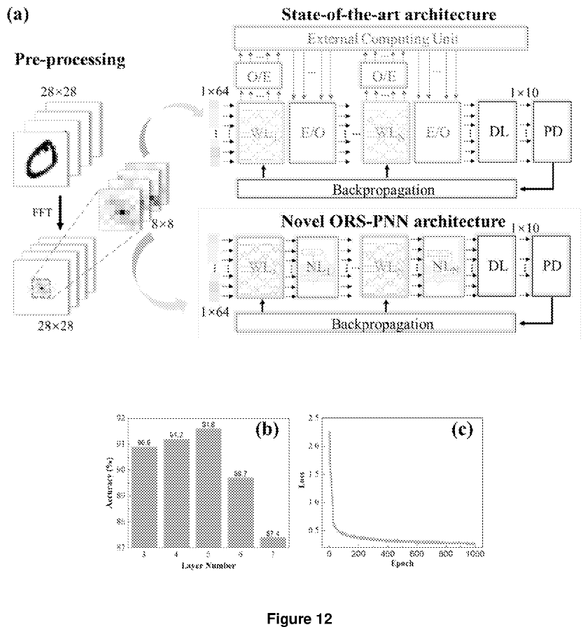

To validate the functionality of nonlinear accelerator according to embodiments of the invention, a fully connected photonic neural network equipped with an ORS-based nonlinear accelerator is implemented in the simulation. The schematic of this network for a MNIST handwritten digits classification task is shown in FIG. 12(a). This MNIST dataset contains 70,000 greyscale images with 28×28 pixel, which is a representative database for neural network model training.

To reduce the input data dimension, Fast Fourier Transform (FFT) and edge-removal are used to convert real images into k-space images. The FFT of 2D image is given by the following equation

$$F ( {k}_{x} , {k}_{y} ) = {\sum }_{m = 0}^{M - 1} {\sum }_{n = 0}^{N - 1} f ( m , n ) {e}^{- j 2 π ( {k}_{x} \frac{m}{M} + {k}_{y} \frac{n}{N} )} \qquad ( 13 )$$

where F(kₓ, k_{y}) is the value of the images in frequency domain corresponding to the coordinates kₓ and k_{y}, f(m,n) is the real pixel at coordinates (m, n), and M and N are the dimensions of the image. The dimension of images is unchanged (28×28) after FFT, the features of images experience centralization since FFT represents spatial frequency distribution of grey level gradients with the lowest frequency in the center and the highest frequency at four corners. Afterwards, removal of fours edges in each image reduces the dimension from 28×28 into 8×8 but preserves most of frequency features. The reasons for using FFT include not only dimensionality reduction but also the feasibility of FFT in integrated photonics.

At the input of photonic neural network equipped with an ORS based accelerator (ORS-PNN) according to embodiments of the invention, input images of shape 8×8 are reconfigured into 64×1. The ORS-PNN starts from several staggered weighting layers (WL) and nonlinear layers (NL) to drop layer (DL), which maps 64 inputs into 10 outputs for ten dights recognition. At the end, photodetectors (PD) convert optical signal into electrical signal for backforward propagation calculation, which optimize WLs in the training process. It is worth mentioning, here, the NL (nonlinear accelerator) adopts softplus nonlinear function as shown in FIG. 5(b). On account of the nonlinear accelerator, the ORS-PNN architecture is more efficient and simplified compared with prior art photonic neural networks, which consume more energy and generate more delays during O/E and E/O conversions. Moreover, prior art photonic neural networks are limited by on-chip space or complexity of network connection with the CPU. Specifically, compared with prior art methods for nonlinear activation function, embodiments of the invention can reduce the average power consumption by 20.2× and shrink the footprint by around 40%.

To observe the dependence of recognition accuracy on the layer number, FIG. 12(b) shows the testing accuracy of an ORS-PNN with different number of WL-NL layers. The accuracy reaches a peak at 91.6% with 5 WL-NL layers as previously shown in FIG. 6. The corresponding loss has an abrupt dropdown, equivalently fast iteration, before 50 epochs with a batch size of 500 in network training as shown in FIG. 12(c). The confusion matrix for 5-layer ORS-PNN computed over the testing dataset (see FIG. 6) shows the correct prediction for each digit image. Overall, these results demonstrate the possibility of accelerating a photonic neural network using an ORS based nonlinear accelerator according to embodiments of the invention.

According to embodiments of the invention, the nonlinear accelerator based on MoS₂ ORS provides an avenue for the realization of in-situ photonic neural networks. A relatively simple architecture, low energy consumption and small chip size enable embodiments to have a wide field of applications. Embodiments of the invention can be further extended to the acceleration of more types of neural networks, such as convolutional neural networks (CNN), recurrent neural networks (RNN) and long short term memory networks (LSTM). Moreover, with the incorporation of MWM technology, embodiments may be capable of computing with high parallelism using different wavelengths, as shown in FIG. 9(i).

In summary, the ORS according to embodiments of the invention distinguishes itself from typical photonics components, e.g. photodetector, with the unique functionality to perform as a nonlinear switch, which is critical to the functionality of the accelerator. This is possible by leveraging on the linear relationship that exists between the input optical power and the voltage that leads to abrupt resistance switching. The reason for this unique characteristic is that optical input generates more heat, from photocurrent-induced Joule heating and optical power dissipation, inducing the vacancy movement to speed up the switching process. From a viewpoint of architecture, a nonlinear accelerator according to embodiments of the invention has the potential to significantly outperform the previous nonlinear activation architectures in terms of energy efficiency and complexity. Further, a nonlinear accelerator according to embodiments of the invention is very compact with a small footprint, so as to pave the way for promising in-situ photonic neural networks with ultra-high computation speed and parallelism.

The following describes the various features and associated technical advantages of embodiments of the invention.

| Feature | Advantage |
|---|---|
| Program- | Different tasks and datasets require different types of |
| mable | nonlinear activation function in a neural network. |
| | Programmability is important to extend the application |
| | range of a photonics neural network. The nonlinear |
| | accelerator architecture according to embodiments of |
| | the invention enable different types of nonlinear activation |
| | functions through easily adjusting some of external |
| | components with electrical control. |
| Optical- | The architecture according to embodiments of the invention |
| electrical | is constructed by the combination of electrical control unit |
| hybrid | and photonics components. The hybrid architecture is more |
| computing | efficient and applicable than pure electronic architecture |
| architecture | and photonic architecture. |
| Low power | The architecture according to embodiments of the invention |
| consumption | has low power consumption due to little loss in the |
| | photonics components and little electrical power needed for |
| | control unit (less than 100 μW). Moreover, it is an in-situ |
| | architecture, which largely reduces the interconnection |
| | loss in the nonlinear accelerator. |
| Optical | The optical resistance switch (ORS) according to |
| resistance | embodiments of the invention has a novel photo-response |
| switch | characteristic: the resistance switching behavior is related |
| | to the input optical power with strong linearity. The ORS |
| | provides real-time responding capability that allows direct |
| | conversion of optical information into electrical signals |
| | for the electrical control unit. |
| Ease of | The architecture according to embodiments of the invention |
| large- | is compatible with traditional CMOS processes. Moreover, |
| scale | the solution-based method determines the scalability of the |
| integration | optical resistance switch. |
| Ultra-high | Due to the little variation of photo-response characteristic |
| calculation | of the optical resistance switch, the nonlinear activation |
| accuracy and | function enabled by embodiments of the invention is stable |
| speed | and has ultra-high calculation accuracy. Moreover, the in- |
| | situ architecture is conducive for lowering latency during |
| | many cycles of neural network training. |
| Support of | The architecture according to embodiments of the invention |
| in-situ | allows frequent access, which is required by neural network |
| neural | training. Compared with external/offline training, in-situ |
| network | training can update the parameters faster and is more |
| training | applicable for real-time learning in robots. |
| Ability to | The accelerator according to embodiments of the invention |
| integrate with | can be regarded as a separate functional module for a fast |
| different | plug-and-play solution. |
| photonics | |
| neural | |
| network | |
| fundamental | |
| frameworks | |

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A photonic neural network accelerator, comprising:
a Mach Zehnder Interferometer (MZI) comprising phase change material (PCM), the MZI configured to modulate input light passing through a main waveguide;
an optical coupler disposed on the main waveguide and configured to split a fraction of the modulated input light into a sub-waveguide from the main waveguide; and
an optical resistance switch (ORS) disposed on the sub-waveguide and configured to capture optical information in the sub-waveguide, wherein the optical information comprises optical power and incident wavelength.

2. The photonic neural network accelerator according to claim 1, wherein the ORS comprises:
an active material configured to absorb the fraction of the modulated input light to drive a photo-response resistance switching process of the ORS, wherein the photo-response resistance switching process of the ORS converts the fraction of the modulated input light into an electrical signal.

3. The photonic neural network accelerator according to claim 2, further comprising:
an electrical control unit (ECU) to simultaneously drive the ORS and MZI.

4. The photonic neural network accelerator according to claim 3, wherein the ORS further comprises:
an electrode configured to send the electrical signal to the ECU.

5. The photonic neural network accelerator according to claim 4, wherein the ECU is configured to:
detect the electrical signal; and
send a corresponding feedback control signal to the MZI for re-modulation of input light passing through the main waveguide.

6. The photonic neural network accelerator according to claim 5, wherein the ECU is configured to send the corresponding feedback control signal to the MZI for re-modulation of the input light until the photo-response resistance switching process of the ORS is reset.

7. The photonic neural network accelerator according to claim 2, wherein the active material comprises a Molybdenum disulfide (MoS₂) switching material configured to capture the optical information.

8. The photonic neural network accelerator according to claim 7, wherein the ORS further comprises:
a micro-mirror to redirect the fraction of the modulated input light into the MoS₂ switching material.

9. The photonic neural network accelerator according to claim 7, wherein the MoS₂ switching material comprises a film spin-coated on another electrode from a MoS₂ ink.

10. The photonic neural network accelerator according to claim 9, wherein the MoS₂ ink is obtained through an electrochemical intercalation assisted exfoliation of a MoS₂ bulk.

11. The photonic neural network accelerator according to claim 1, wherein the photonics neural network accelerator is capable of executing a nonlinear activation function.

12. The photonic neural network accelerator according to claim 2, wherein the active material is configured to exhibit linear resistance switching with respect to the optical power.

13. A photonic neural network comprising a photonics neural network accelerator according to claim 1.

14. A method of fabricating a photonic neural network accelerator, comprising:
providing a Mach Zehnder Interferometer (MZI) comprising phase change material (PCM), the MZI configured to modulate input light passing through a main waveguide;
providing an optical coupler disposed on the main waveguide, wherein the optical coupler is configured to split a fraction of the modulated input light into a sub-waveguide from the main waveguide; and
providing an optical resistance switch (ORS) disposed on the sub-waveguide, wherein the ORS is configured to capture optical information in the sub-waveguide, and wherein the optical information comprises optical power and incident wavelength.

15. The method according to claim 14, further comprising providing the ORS with an active material that is configured to absorb the fraction of the modulated input light to drive a photo-response resistance switching process of the ORS, wherein the photo-response resistance switching process of the ORS converts the fraction of the modulated input light into an electrical signal.

16. The method according to claim 15, further comprising: providing an electrical control unit (ECU) to simultaneously drive the ORS and MZI.

17. The method according to claim 16, further comprising: providing the ORS with an electrode that is configured to send the electrical signal to the ECU.

18. The method according to claim 15, wherein the active material comprises a Molybdenum disulfide (MoS₂) switching material configured to capture the optical information.

19. The method according to claim 18, further comprising: providing the ORS with a micro-mirror to redirect the fraction of the modulated input light into the MoS₂ switching material.

20. The method according to claim 18, wherein the MoS₂ switching material comprises a film spin-coated on another electrode from a MoS₂ ink, and wherein the MoS₂ ink is obtained through an electrochemical intercalation assisted exfoliation of a MoS₂ bulk.
